(19) United States
(12) Patent Application Publication
(10) Pub. No.: US 2022/0270301 A1
(43) Pub. Date: Aug. 25, 2022

(54) IMAGE INTEGRATING METHOD AND SYSTEM

(71) Applicant: MERGERITY CO., LTD., Seoul (KR)

(72) Inventors: Pan Jong KIM, Seoul (KR); Bae Young MYUNG, Gimpo-si, Gyeonggi-do (KR); Sung Hoon YOO, Seoul (KR)

(21) Appl. No.: 17/635,522

(22) PCT Filed: Jul. 19, 2021
(86) PCT No.: PCT/KR2021/009269

§ 371 Date: Feb. 15, 2022

(30) Foreign Application Priority Data
Aug. 28, 2020 (KR) 10-2020-0109718
Oct. 13, 2020 (KR) 10-2020-0132274

(51) Int. Cl. G06T 11/00; G06T 1/60; G06T 7/32; G06T 7/11

(52) U.S. Cl. CPC G06T 11/00; G06T 1/60; G06T 7/32; G06T 7/11; G06T 2207/20021; G06T 2207/20221

(57) ABSTRACT

An image integrating method performed in a computer system includes an image storing operation in which at least one processor included in the computer system stores a first image of a first object and a second image of a second object, an object characteristic information generating operation in which the at least one processor generates first object characteristic information and second object characteristic information regarding at least one of information on an appearance and an outer surface of the respective objects from the first image and the second image, an indicator calculating operation in which the at least one processor calculates a probability indicator that the first object and the second object are the same object by comparing the first object characteristic information with the second object characteristic information, and an image integrating operation in which the at least one processor integrates the first image and the second image to an image for the same object and stores the integrated image when the probability indicator is equal to or greater than a reference value.

### TECHNICAL FIELD

The present disclosure relates to an image integrating method, and more particularly, to a method and system for integrating augmented reality images captured in different views into a single image and storing the integrated single image.

### BACKGROUND ART

With the wide spread of terminals such as smartphones and tablet computers equipped with high-performance cameras become popular, it has become easy to take high-quality photos or videos of surrounding objects. In addition, these terminals support high-speed wireless communication in many cases, and thus, it is also easy to upload such images to a server via the Internet.

Recently, a method of imaging an object in multiple directions while a terminal rotates around at least a portion of the object, rather than imaging the object only in one direction using such a terminal, is supported. using this method, shape information of an actual object may be better expressed because information from two or more views are collected for the object.

Various services using image information captured in multiple directions have been attempted. In order for these services to be smoothly provided, images captured in as many directions as possible for an object are required. However, general users feel considerable inconvenience and inexperience in shooting, while turning around an object entirely (360°).

It is assumed that the aforementioned service has a function of recognizing an object no matter in which direction the object is imaged and a pre-stored image is captured, while rotating around a half (180°) of an object, rather than the whole of the object. In this situation, if the same object is imaged in a different direction, not the already imaged half, a problem arises in that a service provider may not recognize the object imaged by the user.

Therefore, various attempts have been made on a method for solving the problem.

### RELATED ART DOCUMENT

Korean Patent Registration No. 10-2153990

### DISCLOSURE

### Technical Problem

An aspect of the present disclosure provides a method for integrating different images obtained by imaging the same object into a single image and storing and managing the integrated single image.

Another aspect of the present disclosure provides a method of calculating a probability indicator in which an object of the two images, captured in different views by different terminals, is the same object.

### Technical Solution

According to an aspect of the present disclosure, there is provided an image integrating method performed in a computer system including: an image storing operation in which at least one processor included in the computer system stores a first image of a first object and a second image of a second object; an object characteristic information generating operation in which the at least one processor generates first object characteristic information and second object characteristic information regarding at least one of information on an appearance and an outer surface of the respective objects from the first image and the second image; an indicator calculating operation in which the at least one processor calculates a probability indicator that the first object and the second object are the same object by comparing the first object characteristic information with the second object characteristic information; and an image integrating operation in which the at least one processor integrates the first image and the second image to an image for the same object and stores the integrated image when the probability indicator is equal to or greater than a reference value.

In the image integrating method according to an embodiment of the present disclosure, the first image and the second image may be augmented reality images.

In the image integrating method according to an embodiment of the present disclosure, the first image and the second image may be images captured, while turning around a surrounding of the first object and the second object in a certain range.

In the image integrating method according to an embodiment of the present disclosure, in the object characteristic information generating operation, an appearance of the object may be divided by a dividing line in a horizontal direction and divided into a plurality of partial images arranged in a vertical direction, and the object characteristic information may include information on any one of a shape, a color, a length, an interval, and a ratio of the partial image.

In the image integrating method according to an embodiment of the present disclosure, in the object characteristic information generating operation, the appearance of the object may be analyzed to select any one of a plurality of reference appearances pre-stored in the computer system, and the object characteristic information may include information on any one selected reference appearance.

In the image integrating method according to an embodiment of the present disclosure, in the object characteristic information generating operation, the outer surface of the object may be divided by a dividing line in a vertical direction and divided into a plurality of partial images arranged in a horizontal direction, and the object characteristic information may include information on at any one of a pattern and a color of the partial image and text included in the partial image.

In the image integrating method according to an embodiment of the present disclosure, the object characteristic information generating operation may include: a height recognizing operation of recognizing an image capture height of the object from the first image or the second image; and a height correcting operation of correcting the first image or the second image so that the image capture height becomes a predetermined reference height.

In the image integrating method according to an embodiment of the present disclosure, the indicator calculating operation may include: a vertical partial image identifying operation of identifying a vertical partial image divided by the dividing line in a vertical direction from the first object characteristic information and the second object characteristic information; and an overlapping region selecting operation of selecting at least one vertical partial image corresponding to an overlapping region by comparing respective vertical partial images of the first object characteristic information and the second object characteristic information.

In the image integrating method according to an embodiment of the present disclosure, the probability indicator may be calculated based on a correlation of at least one vertical partial image corresponding to the overlapping region, among the first object characteristic information and the second object characteristic information.

In the image integrating method according to an embodiment of the present disclosure, the at least one vertical partial image corresponding to the overlapping region may be a plurality of vertical partial images continuous with each other.

In the image integrating method according to an embodiment of the present disclosure, the image storing operation may include a first image storing operation of storing the first image and a second image storing operation of storing the second image, the object characteristic information generating operation may include: a first object characteristic information generating operation of generating the first object characteristic information and a second object characteristic information generating operation of generating the second object characteristic information, the second image storing operation may be performed after the first object characteristic information generating operation, and when the probability indicator is equal to or greater than the reference value, the image integrating method may further include an additional second image storing operation in which the at least one processor stores an additional second image added to the second image.

In the image integrating method according to an embodiment of the present disclosure, the second image and the additional second image may be captured from a single terminal connected to the computer system via a network.

In the image integrating method according to an embodiment of the present disclosure, when the probability indicator is equal to or greater than the reference value, the image integrating method may further include: an additional second image registration mode providing operation in which the at least one processor supports capturing and transmission of the additional second image to a terminal connected to the computer system via a network.

In the image integrating method according to an embodiment of the present disclosure, in the operation of providing the additional second image registration mode, the at least one processor may provide the additional second image registration mode such that a portion corresponding to the second image and a portion corresponding to the additional second image are displayed to be distinguished from each other in the terminal.

In the image integrating method according to an embodiment of the present disclosure, in the operation of providing the additional second image registration mode, the portion corresponding to the additional second image and the portion corresponding to the additional second image may be displayed in a virtual circular shape surrounding the second object, and the portion corresponding to the second image and the portion corresponding to the additional second image may be displayed in different colors.

According to another aspect of the present disclosure, there is provided a computer system including: a memory; and at least one processor connected to the memory and configured to execute instructions, wherein the at least one processor includes: an image storing unit configured to store a first image of a first object and a second image of a second object; an object characteristic information generating unit configured to generate first object characteristic information and second object characteristic information regarding at least one of information on an appearance and an outer surface of the respective objects from the first image and the second image; an indicator calculating unit configured to calculate a probability indicator that the first object and the second object are the same object by comparing the first object characteristic information with the second object characteristic information; and an image integrating unit configured to integrate the first image and the second image to an image for the same object and stores the integrated image when the probability indicator is equal to or greater than a reference value.

### Advantageous Effects

In the image integrating method according to an embodiment of the present disclosure, different images obtained by imaging the same object may be integrated into a single image and stored and managed.

In addition, in the image integrating method according to an embodiment of the present disclosure, for two different images captured at different views by different terminals, a probability indicator that objects of the two images are the same object may be calculated.

### DESCRIPTION OF DRAWINGS

FIG. 1 is a block diagram illustrating a connection relationship of a computer system in which an image integrating method of the present disclosure is performed.

FIG. 2 is a block diagram of a computer system for performing an image integrating method of the present disclosure.

FIG. 3 is a flowchart of an image integrating method of the present disclosure.

FIG. 4 is a diagram schematically illustrating contents of a first image and a second image according to an embodiment of the present disclosure.

FIG. 5 schematically illustrates an example of a method for a processor to generate object characteristic information from an object according to an embodiment of the present disclosure.

FIG. 6 is a view illustrating a partial image according to an embodiment of the present disclosure.

FIG. 7 is a view illustrating an example of an indicator calculating step according to an embodiment of the present disclosure.

FIG. 8 is a diagram illustrating an example of an image integrating step according to an embodiment of the present disclosure.

FIG. 9 is a diagram illustrating an example of an additional image registration mode providing step according to an embodiment of the present disclosure.

FIG. 10 is a diagram illustrating an example of an additional image storing step according to an embodiment of the present disclosure.

### BEST MODES

Hereinafter, embodiments of the present invention will be described in detail with reference to the accompanying drawings. In describing the present invention, if it is determined that a detailed description of known functions and components associated with the present invention unnecessarily obscure the gist of the present invention, the detailed description thereof will be omitted. The terms used henceforth are used to appropriately express the embodiments of the present invention and may be altered according to a person of a related field or conventional practice. Therefore, the terms should be defined on the basis of the entire content of this specification.

Technical terms used in the present specification are used only in order to describe specific exemplary embodiments rather than limiting the present invention. The terms of a singular form may include plural forms unless referred to the contrary. It will be further understood that the terms “comprise” and/or “comprising,” when used herein, specify the presence of stated features, integers, steps, operations, elements, and/or components, but do not preclude the presence or addition of one or more other features, regions, integers, steps, operations, elements, components, and/or groups thereof

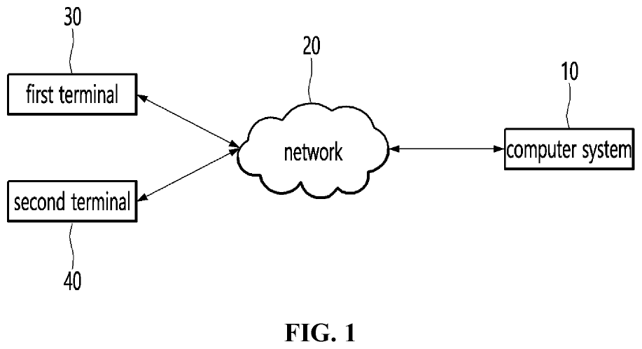

Hereinafter, an image integrating method according to an embodiment of the present disclosure will be described with reference to the accompanying FIGS. 1 to 10.

FIG. 1 is a diagram briefly illustrating a connection relationship of a computer system 10 in which an image integrating method of the present disclosure is performed.

Referring to FIG. 1, a computer system 10 of the present disclosure may be configured as a server connected to a network 20. The computer system 10 may be connected to a plurality of terminals via the network 20.

Here, a communication method of the network 20 is not limited, and a connection between each component may not be connected in the same network method. The network 20 may include not only a communication method using a communication network (e.g., a mobile communication network, wired Internet, wireless Internet, a broadcasting network, a satellite network, etc.) but also short-range wireless communication between devices. For example, the network 20 may include all communication methods through which objects may network, and is not limited to wired communication, wireless communication, 3G, 4G, 5G, or other methods.

For example, the wired and/or network 20 may include a communication network based on one or more communication methods selected from the group consisting of local area network (LAN), metropolitan area network (MAN), global system for mobile network (GSM), enhanced data GSM environment (EDGE), high speed downlink packet access (HSDPA), wideband code division multiple access (W-CDMA), CDMA, time division multiple access (TDMA), Bluetooth, Zigbee, Wi-Fi, voice over Internet protocol (VoIP), LTE advanced, IEEE802.16m, WirelessMAN-Advanced, HSPA+, 3GPP long term evolution (LTE), mobile WiMAX (IEEE 802.16e), UMB (formerly EV-DO Rev. C), Flash-OFDM, iBurst and MBWA (IEEE 802.20) systems, HIPERMAN, beam-division multiple access (BDMA), world interoperability for microwave access (Wi-MAX), and ultrasound-based communication, but are not limited thereto.

The terminals may have a camera device capable of capturing an image. Terminals may include mobile phones, smartphones, laptop computers, digital broadcasting terminals, personal digital assistants (PDA), portable multimedia players (PMPs), navigation systems, slate PCs, tablet PCs, ultrabook, wearable devices (e.g., watch-type terminals (smartwatches), glass-type terminals (smart glasses), head mounted displays (HMDs), etc.

The terminals may include a communication module and transmit and receive wireless signals to and from at least one of a base station, an external terminal, and a server in a mobile communication network established according to technical standards or communication methods for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSDPA), long term evolution (LTE), long term evolution-advanced (LTE-A), etc.).

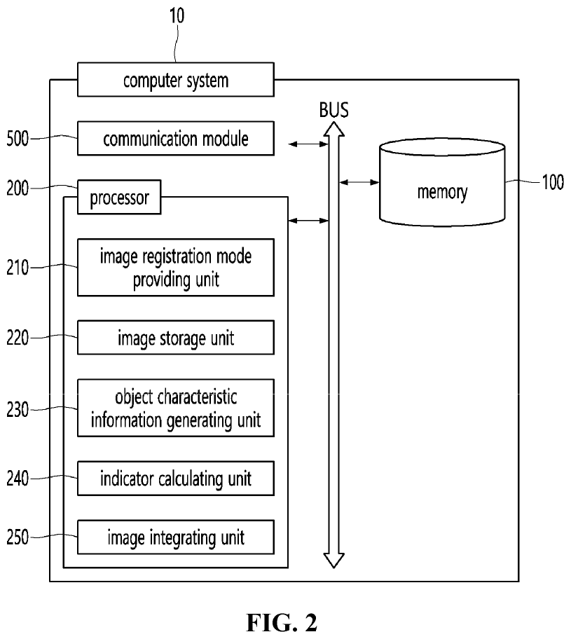

FIG. 2 is a block diagram of the computer system 10 for performing the image integrating method of the present disclosure.

Referring to FIG. 2, the computer system 10 may include a memory 100 and a processor 200. In addition, the computer system 10 may include a communication unit that may be connected to the network 20.

Here, the processor 200 is connected to the memory 100 and is configured to execute an instruction. The instruction refers to a computer readable instruction included in the memory 100.

The processor 200 includes an image registration mode providing unit 210, an image storage unit 220, an object characteristic information generating unit 230, an indicator calculating unit 240, and an image nitrating unit 250.

The memory 100 may store a database including images and object characteristic information for the images.

Each part of the process described above will be described after the image integrating method is described.

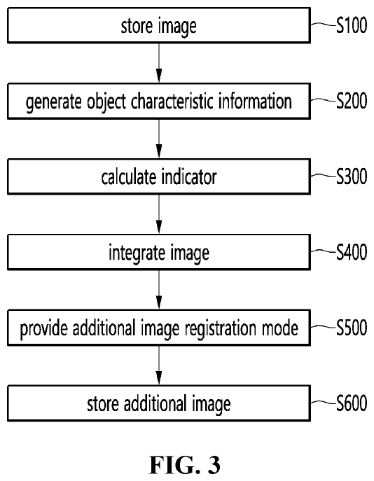

FIG. 3 is a flowchart of an image integrating method of the present disclosure.

Referring to FIG. 3, the image integrating method of the present disclosure includes an image storing step, an object characteristic information generating step, an indicator calculating step, an image integrating step, an additional image 330 registration mode providing step, and an additional image 330 storing step.

Each of the steps described above is performed in the computer system 10. Specifically, each of the steps described above is performed by at least one processor 200 included in the computer system 10.

Each of the steps described above may be performed irrespective of the listed order, except when performed in the listed order due to a special causal relationship.

Hereinafter, the image storing step will be described.

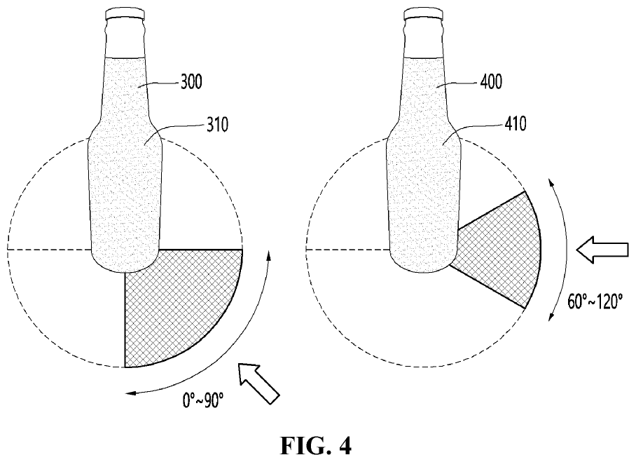

The image storing step will be described with reference to FIG. 4.

In the image storing step, at least one processor 200 included in the computer system 10 stores a first image 310 of a first object 300 and a second image 410 of a second object 400.

This image storing step may be performed after the image registration mode providing step is performed, and capturing is performed in response to the image registration mode provided in the user's terminal.

The computer system 10 receives a captured image from at least one terminal through the network 20. The computer system 10 stores the received image in the memory 100.

Here, the image may include a plurality of images. For convenience of description, it is assumed that the image includes a first image 310 and a second image 410. Also, it is assumed that the first image 310 is an image for the first object 300 and the second image 410 is an image for the second object 400.

Here, the image may be an augmented reality (AR) image. Also, the image may be an image captured to be generated, while turning around the object in a certain range. The image may be an image of the entire surrounding area (360°)of the object, but hereinafter, it is assumed that only a partial range (less than 360°) is imaged.

Specifically, the image saving step may include a first image 310 storing step of storing the first image 310 and a second image 410 storing second image 410 storing step. In addition, the first image 310 storing step and the second image 410 storing step may be temporally spaced apart from each other.

As will be described in detail below, after the first image 310 storing step is performed, the second image 410 storing step may be performed after the first object 300 characteristic information generating step is performed.

FIG. 4 is a diagram schematically illustrating the contents of the first image 310 and the second image 410.

The contents of the first image 310 and the second image 410 will be briefly described.

As described above, the first image 310 is an image of the first object 300, and the second image 410 is an image of the second object 400. However, the first object 300 and the second object 400 may be the same object. However, if the first image 310 and the second image 410 are obtained by imaging different portions thereof by different subjects and at different views based on different subjects, it may be difficult for the computer system 10 to recognize immediately whether the first object 300 and the second object 400 are the same object.

Here, when the first object 300 and the second object 400 are the same object, it means that they are not only physically the same object, but also physically different objects but have the same features in appearance and outer surface, that is, the same type of objects.

As shown in FIG. 4, the first image 310 may be an image obtained by imaging the first object 300 in a range of 0° to 90° based on a certain specific reference point. In addition, the second image 410 may be an image obtained by imaging the second object 400 which is the same as the first object 300 in a range of 60° to 120° based on the same specific reference point.

Hereinafter, the object characteristic information generating step will be described.

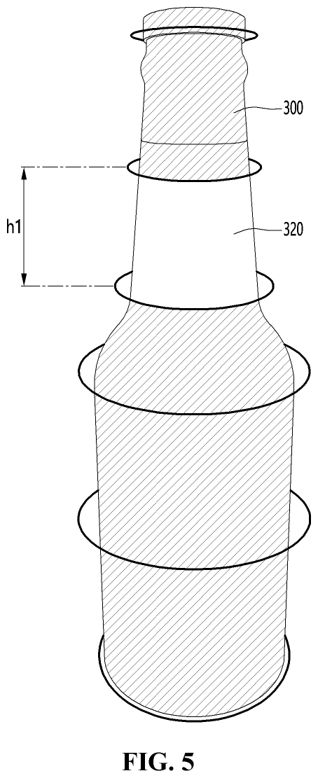

The object characteristic information generating step will be described with reference to FIGS. 5 to 7.

In the object characteristic information generating step, at least one processor 200 included in the computer system 10 generates first object 300 characteristic information and second object 400 characteristic information regarding at least one of information on an appearance and outer surface of each object from the first image 310 and the second image 410.

The object characteristic information refers to information obtained by extracting a characteristic related to at least one of information on an appearance and an outer surface of an object by the processor 200 from an image.

The object characteristic information may include first object 300 characteristic information and second object 400 characteristic information. The first object 300 characteristic information is information on at least one of an appearance and an outer surface of the first object 300 extracted from the first image 310. The second object 400 characteristic information is information on at least one of an appearance and an outer surface of the second object 400 extracted from the second image 410.

Specifically, the object characteristic information generating step may include the first object 300 characteristic information generating step of generating the first object 300 characteristic information and the second object 400 characteristic information generating step of generating the second object 400 characteristic information. Also, the first object 300 characteristic information generating step and the second object 400 characteristic information generating step may be performed to be temporally spaced apart from each other.

Specifically, the first image 310 storing step may be first performed, and the first object 300 characteristic information generating step may be performed. Thereafter, the second image 410 storing step may be performed, and the second object 400 characteristic information generating step may be performed.

FIG. 5 schematically illustrates an example of a method for the processor 200 to generate object characteristic information from an object.

Referring to FIG. 5, the object characteristic information may include any one information among a shape, color, length, interval, and ratio of a partial image 320.

Here, the partial image 320 refers to an image obtained by dividing an external appearance of an object by a dividing line in one direction. As shown in FIG. 5, the partial image 320 may be an image obtained by dividing the external appearance of an object by a dividing line in a horizontal direction and arranged in a vertical direction. One image may include a plurality of partial images 320.

These partial images 320 may be divided according to visual characteristics. For example, as shown in FIG. 5, one object may be divided by a plurality of dividing lines based on bending of an outer line.

The partial image 320 may have various visual characteristics. For example, as shown in FIG. 5, one partial image 320 may have characteristics such as a unique shape, color, length, interval, and ratio. Specifically, one partial image 320 among the partial images 320 shown in FIG. 5 may have a vertical length of hl, a color of light gold, and a cross-sectional shape of a trapezoidal shape with a wide bottom.

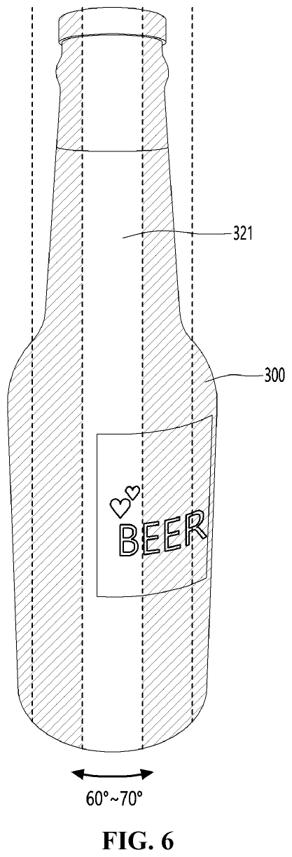

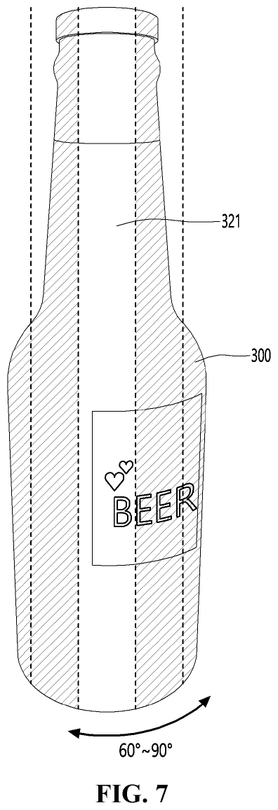

FIGS. 6 and 7 schematically illustrate another example of a method for the processor 200 to generate object characteristic information from an object.

Referring to FIG. 6, the object characteristic information may include information on any one of a pattern and a color of the partial image and text included in the partial image 320.

Here, the partial image 320 refers to an image obtained by dividing an outer surface of an object by a dividing line in one direction. As shown in FIG. 6, the partial image 321 may be an image obtained by dividing an outer surface of an object by a dividing line in a vertical direction and arranged in a horizontal direction. Also, one image may include a plurality of partial images 321.

The partial image 321 may be divided according to an angle at which the camera moves with respect to the center of the object. For example, as shown in FIG. 7, the partial image 321 may be divided into a range of 10° according to an image capture angle.

The partial image 321 may have various visual characteristics. For example, as shown in FIG. 6, one partial image 321 may have characteristics such as a unique pattern and color. Also, one partial image 321 may have characteristics for text included therein. Specifically, one partial image 320 among the partial images 321 shown in FIG. 6 may have a feature that there are two images of hearts on a white background and text B is described.

Although not shown in the drawings, the object characteristic information may include information on a reference appearance estimated by analyzing an appearance of the object. The reference appearance information refers to general appearance information of various objects stored in advance in the computer system 10. For example, the computer system 10 may store, in the memory 100, general and various appearance information of beer bottles collected in advance for the beer bottles. The processor 200 may analyze the appearance of the object from the image and select which of the plurality of reference appearance stored in advance in the computer system 10 corresponds to the appearance of the object. In addition, the processor 200 may generate the image including reference appearance information selected as object characteristic information of the corresponding image.

Also, although not shown in the drawings, the object characteristic information generating step may include a height recognition step and a height correction step.

The height recognition step is a step of recognizing an image capture height of the object from the image. The height correction step is a step of correcting the image so that the image capture height becomes a predetermined reference height.

An image difference that may occur may be reduced. Accordingly, a difference in object characteristic information that may occur due to a difference in imaged height may also be reduced.

Hereinafter, an indicator calculating step will be described.

The indicator calculating step will be described with reference to FIG. 7.

In the indicator calculating step, at least one processor 200 included in the computer system 10 calculates a probability indicator that the first object 300 and the second object 400 are the same object by comparing the first object characteristic information and the second object 400 characteristic information.

The indicator calculating step may include a vertical partial image 321 identifying step and an overlapping region selecting step.

The vertical partial image 321 identifying step is a step of identifying the vertical partial image 321 divided by a dividing line in the vertical direction from the first object 300 characteristic information and the second object 400 characteristic information. The vertical partial image 321 may be divided according to an angle at which the camera moves with respect to the center of the object. For example, as shown in FIG. 7, the vertical partial image 321 may be divided into a range of 10° according to an image capture angle.

In the overlapping region selecting step, at least one vertical partial image 321 corresponding to the overlapping region is selected by comparing the vertical partial image 321 of each of the first object 300 characteristic information and the second object 400 characteristic information. For example, referring to FIG. 7, three vertical partial images 321 in the 10° range corresponding to the 60° to 90° range of the object based on a certain specific reference point may correspond to the overlapping region.

The overlapping region may include one or a plurality of vertical partial images 321. When the overlapping region includes a plurality of vertical partial images 321, the plurality of vertical partial images 321 may be continuous with each other. Referring to the example shown in FIG. 7, the three vertical partial images 321 are continuous with each other in the range of 60° to 90°.

Whether it corresponds to the overlapping region may be determined by comprehensively comparing information on the appearance and the outer surface of each vertical partial image 321.

The probability indicator that the first object 300 and the second object 400 are the same object may be calculated based on a correlation of at least one vertical partial image 321 corresponding to the overlapping region, among the first object image 300 characteristic information and the second object 400 characteristic information. That is, the vertical partial image 321 corresponding to the range of 0° to 60° that does not correspond to the overlapping region among the first object 300 characteristic information and the vertical partial image 321 corresponding to the range of 90° to 120° that does not correspond to the overlapping region among the second object 400 characteristic information may not be a basis for calculating the probability indicator.

Hereinafter, the image integrating step will be described.

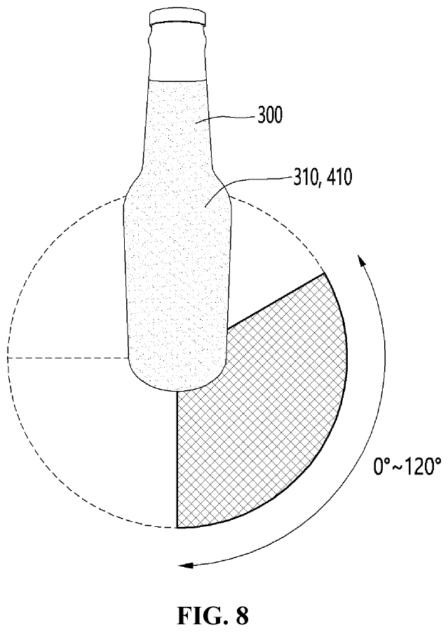

The image integrating step will be described with reference to FIG. 8.

The image integrating step is a step in which at least one processor 200 included in the computer system 10 integrates the first image 310 and the second image 410 into an image of the same object and stores the integrated image. This image integrating step is performed when the probability indicator in the indicator calculating step is greater than or equal to a predetermined reference value.

Referring to FIG. 8, when the probability indicator is equal to or greater than the predetermined reference value, the processor 200 may integrate the first image 310 and the second image 410 as an image for the same object and store the integrated image, rather than recognizing the first image 310 ant the second image 410 as images for the first object 300 and the second object 400 and storing and managing them, respectively.

Hereinafter, the additional image 300 registration mode providing step will be described.

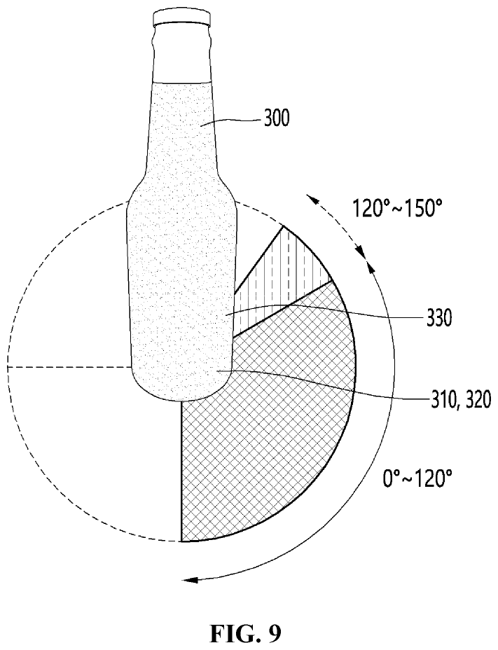

The additional image 300 registration mode providing step will be described with reference to FIG. 9.

The additional image 330 registration mode providing step may be performed when the first image 310 storing step is first performed, the first object 300 characteristic information generating step is performed, the second image 410 storing step is performed, and then, the second object 400 characteristic information generating step is performed. In addition, the additional image 330 registration mode providing step is performed when the probability indicator in the indicator calculating step is greater than or equal to a predetermined reference value.

Here, the additional image 330 refers to an image added to the second image 410. In addition, the additional image 330 is captured from a single terminal connected to the computer system 10 via the network 20.

The additional image 300 registration mode providing step is a step in which at least one processor 200 included in the computer system 10 stores the additional image 330 added to the second image 410.

The additional image 330 may be an image in a continuous range from an image capture end point of the second image 410. Referring to FIG. 9, the additional image 330 may be an image in the range of 120° to 150° that is continuously added at 120°, which is the image capture end point of the second image 410.

In the additional image 330 registration mode, a user interface for additionally capturing, integrating, storing and registering an image is provided to the terminal providing the second image 410 as an image for the same object as the second object 400 is discovered. To this end, the additional image 330 registration mode provides a user interface supporting image capturing and transmission of the additional image 330.

As shown in FIG. 9, in the user interface, a portion corresponding to the second image 410 and a portion corresponding to the additional image 330 may be displayed to be distinguished from each other in the terminal. Specifically, the portion corresponding to the second image 410 and the portion corresponding to the additional image 330 may be displayed in the form of a virtual circle surrounding the second object 400, and the portion corresponding to the second image 410 and the portion corresponding to the additional image 330 may be displayed in different colors.

Hereinafter, the additional image 330 storing step will be described.

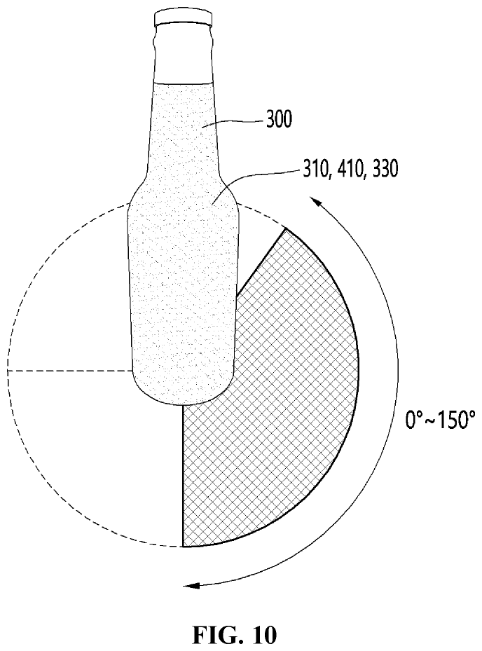

The additional image 330 storing step will be described with reference to FIG. 10.

The additional image 330 storing step is a step in which the at least one processor 200 included in the computer system 10 stores the additional image 330 in the memory 100.

As shown in FIG. 10, the stored additional image 330 may be integrated, stored, and managed as an image for the same object together with the first image 310 and the second image 410.

Hereinafter, an image integrating system according to the present disclosure will be described. The image integrating system will be described with reference to FIG. 2.

Since the image integrating system is a system of performing the image integrating method described above, a detailed description thereof will be replaced with the description of the image integrating method.

The image integrating system is implemented as the computer system 10. This computer system 10 includes the memory 100 and the processor 200. In addition, the computer may include a communication unit that may be connected to the network 20.

Here, the processor 200 is connected to the memory 100 and is configured to execute instructions. The instructions refer to computer-readable instructions included in the memory 100.

The processor 200 includes an image registration mode providing unit 210, an image storage unit 220, an object characteristic information generating unit 230, an indicator calculating unit 240, and an image nitrating unit 250.

The memory 100 may store a database including images and object characteristic information for the images.

The image registration mode providing unit 210 provides a user interface for capturing an image in the terminal and transmitting the captured image to the computer system 10.

The image storage unit 220 stores the first image 310 of the first object 300 and the second image 410 of the second object 400. The image storage unit 220 performs the image storing step described above.

The object characteristic information generating unit 230 generates first object characteristic information and second object characteristic information related to at least one of information on an appearance and outer surface of the objects, respectively, from the first image 310 and the second image 410. The object characteristic information generating unit 230 performs the object characteristic information generating step described above.

The indicator calculating unit 240 calculates a probability indicator that the first object 300 and the second object 400 are the same object by comparing the first object characteristic information and the second object characteristic information.

When the probability indicator is equal to or greater than a reference value, the image integrator 250 integrates and stores the first image 310 and the second image 410 as an image of the same object. The image integrating unit 250 performs the image integrating step described above.

The technical features disclosed in each embodiment of the present disclosure are not limited only to the corresponding embodiment and may be combined and applied to different embodiments unless they are mutually incompatible.

Embodiments of the image integrating method and system of the present disclosure have been described. The present disclosure is not limited to the embodiments described above and the accompanying drawings, and various modifications and variations may be made from the viewpoint of a person skilled in the art to which the present invention pertains. Therefore, the scope of the present disclosure should be defined by the equivalents of claims of the present disclosure as well as the claims.

10: computer system

20: network

30: first terminal

40: second terminal

100: memory

200: processor

210: image registration mode providing unit

220: image storage unit

230: object characteristic information generating unit

240: indicator calculating unit

250: image integrating unit

300: first object

310: first image

320: partial image

330: additional image

321: vertical partial image

400: second object

410: second image

1. An image integrating method performed in a computer system, the image integrating method comprising:
an image storing operation in which at least one processor included in the computer system stores a first image of a first object and a second image of a second object;
an object characteristic information generating operation in which the at least one processor generates first object characteristic information and second object characteristic information regarding at least one of information on an appearance and an outer surface of the respective objects from the first image and the second image;
an indicator calculating operation in which the at least one processor calculates a probability indicator that the first object and the second object are the same object by comparing the first object characteristic information with the second object characteristic information; and
an image integrating operation in which the at least one processor integrates the first image and the second image to an image for the same object and stores the integrated image when the probability indicator is equal to or greater than a reference value,
wherein, in the object characteristic information generating operation, the appearance of the object is divided into a plurality of partial images divided by a dividing line in a horizontal direction and arranged in a vertical direction, or the outer surface of the object is divided into a plurality of partial images divided by a dividing line in the vertical direction and arranged in the horizontal direction,
when the appearance of the object is divided into a plurality of partial images divided by a dividing line in the horizontal direction and arranged in the vertical direction, the object characteristic information includes information on any one of a shape, a color, a length, an interval, and a rate of the partial image, and
when the outer surface of the object is divided into a plurality of partial images divided by a dividing line in the vertical direction and arranged in the horizontal direction, the object characteristic information includes information on any one of a pattern and a color of the partial image and text included in the partial image.

2. The image integrating method of claim 1, wherein the first image and the second image are augmented reality images.

3. The image integrating method of claim 1, wherein the first image and the second image are images captured, while turning around a surrounding of the first object and the second object in a certain range.

4. The image integrating method of claim 1, wherein, in the object characteristic information generating operation, the appearance of the object is analyzed to select any one of a plurality of reference appearances pre-stored in the computer system, and the object characteristic information includes information on any one selected reference appearance.

5. The image integrating method of claim 1, wherein the object characteristic information generating operation includes:
a height recognizing operation of recognizing an image capture height of the object from the first image or the second image; and
a height correcting operation of correcting the first image or the second image so that the image capture height becomes a predetermined reference height.

6. The image integrating method of claim 1, wherein
the indicator calculating operation includes:
a vertical partial image identifying operation of identifying a vertical partial image divided by the dividing line in a vertical direction from the first object characteristic information and the second object characteristic information; and
an overlapping region selecting operation of selecting at least one vertical partial image corresponding to an overlapping region by comparing respective vertical partial images of the first object characteristic information and the second object characteristic information.

7. The image integrating method of claim 6, wherein the probability indicator is calculated based on a correlation of at least one vertical partial image corresponding to the overlapping region, among the first object characteristic information and the second object characteristic information.

8. The image integrating method of claim 6, wherein the at least one vertical partial image corresponding to the overlapping region is a plurality of vertical partial images continuous with each other.

9. The image integrating method of claim 1, wherein
the image storing operation includes a first image storing operation of storing the first image and a second image storing operation of storing the second image,
the object characteristic information generating operation includes:
a first object characteristic information generating operation of generating the first object characteristic information; and
a second object characteristic information generating operation of generating the second object characteristic information,
the second image storing operation is performed after the first object characteristic information generating operation, and
when the probability indicator is equal to or greater than the reference value, the image integrating method further comprising an additional second image storing operation in which the at least one processor stores an additional second image added to the second image.

10. The image integrating method of claim 9, wherein the second image and the additional second image are captured from a single terminal connected to the computer system via a network.

11. The image integrating method of claim 9, wherein
when the probability indicator is equal to or greater than the reference value, the image integrating method further comprising an additional second image registration mode providing operation in which the at least one processor supports capturing and transmission of the additional second image to a terminal connected to the computer system via a network.

12. The image integrating method of claim 11, wherein,
in the operation of providing the additional second image registration mode, the at least one processor provides the additional second image registration mode such that a portion corresponding to the second image and a portion corresponding to the additional second image are displayed to be distinguished from each other in the terminal.

13. The image integrating method of claim 12, wherein,
in the operation of providing the additional second image registration mode, the portion corresponding to the additional second image and the portion corresponding to the additional second image are displayed in a virtual circular shape surrounding the second object, and the portion corresponding to the second image and the portion corresponding to the additional second image are displayed in different colors.

14. A computer system comprising:
a memory; and
at least one processor connected to the memory and configured to execute instructions,
wherein the at least one processor includes:
an image storing unit configured to store a first image of a first object and a second image of a second object;
an object characteristic information generating unit configured to generate first object characteristic information and second object characteristic information regarding at least one of information on an appearance and an outer surface of the respective objects from the first image and the second image;
an indicator calculating unit configured to calculate a probability indicator that the first object and the second object are the same object by comparing the first object characteristic information with the second object characteristic information; and
an image integrating unit configured to integrate the first image and the second image to an image for the same object and stores the integrated image when the probability indicator is equal to or greater than a reference value.
